(19) United States
(12) Patent Application Publication
(10) Pub. No.: US 2023/0025671 A1
(43) Pub. Date: Jan. 26, 2023

(54) System of Using a Flow Disc to Modify a Spray Pattern of a Fuel Injector

(71) Applicant: Moran Motorsports Inc., Taylor, MI (US)

(72) Inventors: Michael Edward Moran, Taylor, MI (US); Anthony Richard Donnarumma, Garden City, MI (US)

(21) Appl. No.: 17/868,758

(22) Filed: Jul. 19, 2022

Related U.S. Application Data
(60) Provisional application No. 63/223,478, filed on Jul. 19, 2021.

(51) Int. Cl. F02M 61/18

(52) U.S. Cl. CPC F02M 61/1853

(57) ABSTRACT

A system of using a flow disc to modify a spray pattern of a fuel injector is a system used to change the spray pattern of injected fuel to increase the air to fuel ratio of an engine. The system includes a flow disc and a fuel injector. The flow disc modifies the spray pattern of the injected fuel by the fuel injector to increase the air contact with the injected fuel. The flow disc includes a disc body and a plurality of spray holes. The disc body is designed to securely fit within the fuel injector. The arrangement of the plurality of spray holes helps modify the spray pattern of the injected fuel. The fuel injector includes an injector body and a spray tip. The injector body controls the flow of the fuel being injected into the engine. The spray tip serves as the outlet of the fuel injector.

The current application claims a priority to the U.S. provisional patent application Ser. No. 63/223,478 filed on Jul. 19, 2021.

### FIELD OF THE INVENTION

The present invention generally relates to a spherical shaped flow disc. More specifically, the present invention is a device that increases the surface area of the exiting fuel with the surrounding air for fuel injectors.

### BACKGROUND OF THE INVENTION

The motorized vehicle industry creates and innovates various components designed to be more efficient for better suiting racing requirements. Fuel injectors are one main device that has a direct impact on a vehicle's efficiency. Some fuel injectors are designed to utilize flow discs with a circular shape and a plurality of holes to control the flow rate of the fuel. Many fuel injectors do not use flow discs due to the extra costs and the ones that do utilize standard flow discs that limit the potential of the fuel injector, further limiting the potential and efficiency of the overall vehicle. The standard flow discs are limited in their engine output due to a single flow disc thickness, flat shape, limited flow disc holes, and the flow disc hole angles. These standard flow discs result in less surface area that the fuel comes in to contact with due to a more confined pattern which results in a lower efficiency which in turn equates to a lower horsepower output from the engine utilizing the standard flow discs.

An objective of the present invention is to provide users with a flow disc for a fuel injector, to help increase engine efficiency. The present invention intends to provide users with a fuel disc with a unique shape and varying thickness to create an optimal fuel flow rate and fuel spray pattern. In order to accomplish that, a preferred embodiment of the present invention comprises a disc depression, a plurality of holes and an outer disc. Further, the disc depression is specifically designed to increase the surface area of the fuel coming into contact with the surrounding air. Thus, the present invention is flow disc for a fuel injector that is designed with a unique shape and a plurality of holes to improve the flow rate and spray pattern to create a more efficient engine output while utilizing the same amount of fuel.

### SUMMARY OF THE INVENTION

The present invention is a flow disc to help with increasing engine efficiency by improving fuel injectors to better suit racing needs. The present invention seeks to provide users with a flow disc with a unique shape designed to improve the fuel flow rate and the fuel spray pattern of the fuel injector. In order to accomplish this, the present invention comprises a disc depression that creates a larger surface area as the fuel leaves the fuel injector. Further, the plurality of holes allows the user to finely meter the fuel and improve efficiency. Additionally, the outer disc ensures the flow disc has flat area to easily be held within a fuel injector. Thus, the present invention is flow disc for a fuel injector that is designed with a unique shape to improve the flow rate and spray pattern to create a more efficient engine output while utilizing the same amount of fuel.

### BRIEF DESCRIPTION OF THE DRAWINGS

FIG. 1 is an exploded perspective view of the present invention.

FIG. 2 is a schematic cross-sectional view of the present invention.

FIG. 3 is a top perspective view of the flow disc for the present invention.

FIG. 4 is a bottom perspective view of the flow disc for the present invention.

FIG. 5 is a top view of the flow disc for the present invention.

FIG. 6 is a bottom view of the flow disc for the present invention.

FIG. 7 is a side view of the flow disc for the present invention.

### DETAILED DESCRIPTION OF THE INVENTION

All illustrations of the drawings are for the purpose of describing selected versions of the present invention and are not intended to limit the scope of the present invention.

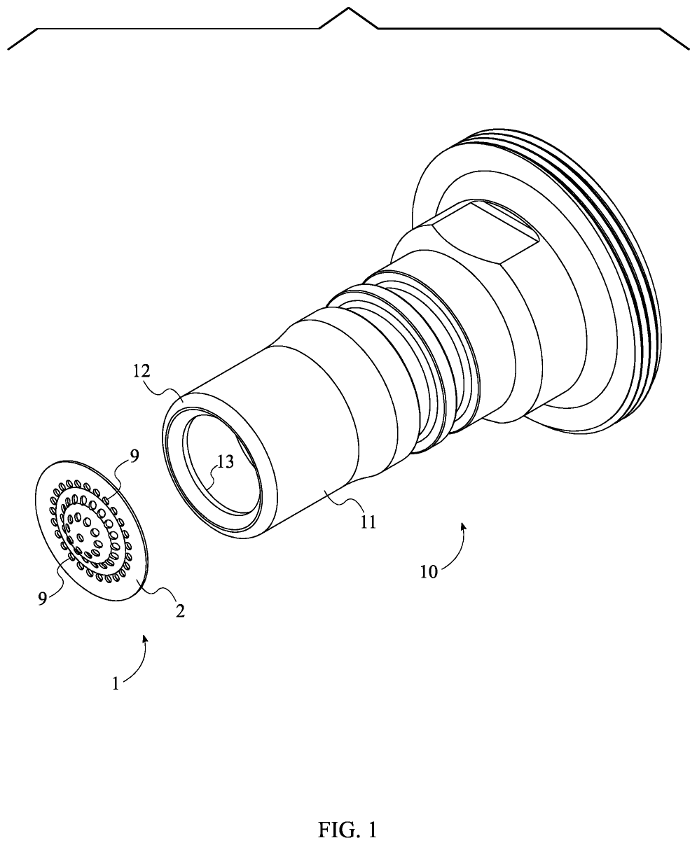

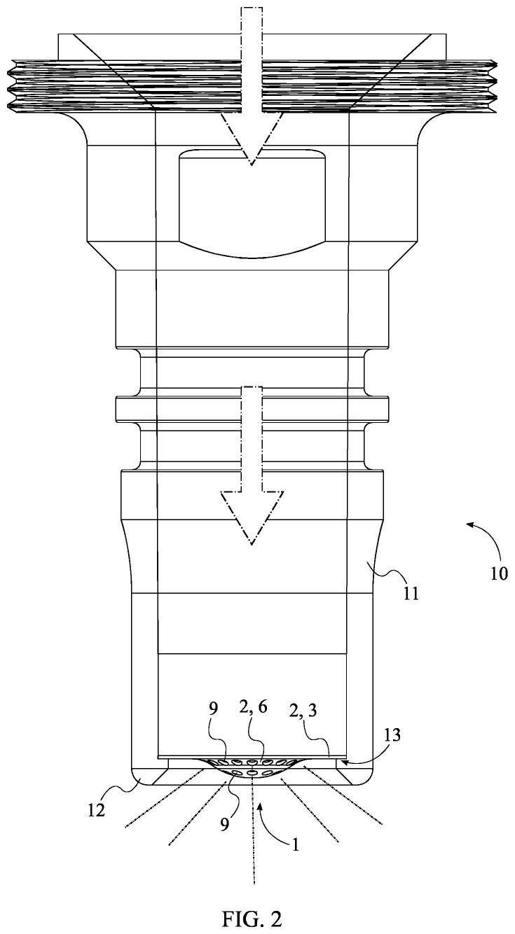

As can be seen in FIGS. 1 and 2, the present invention is a system of using a flow disc to modify a spray pattern of a fuel injector so that the spray pattern being injected into a cylinder can be burned with better fuel efficiency. Thus, the present invention comprises a flow disc 1 and a fuel injector 10. The fuel injector 10 is used to inject a discrete amount of fuel into a cylinder during a combustion cycle. The fuel injector 10 comprises an injector body 11, which is the structural body of the fuel injector 10, and a spray tip 12, which is an outlet end for the fuel injector 10. Moreover, the flow disc 1 is used to shape the spray pattern of the fuel as the fuel is exiting the injector body 11 at the spray tip 12. The flow disc 1 comprises a disc body 2, which is the structural body of the flow disc 1, and a plurality of spray holes 9, which allow the fuel to travel through the flow disc 1. The disc body 2 is preferably made of 304L stainless steel or another kind of stainless steel. In addition, the disc body 2 comprises an annular portion 3 and a dimple portion 6. The dimple portion 6 is a contoured portion of the disc body 2 that plays a large role in shaping the spray pattern of the fuel injector 10. The dimple portion 6 is preferably and geometrically shaped as a spherical cap. The annular portion 3 is the peripheral portion of the disc body 2 that is used to hold the disc body 2 in place within the fuel injector 10. The annular portion 3 is preferably and geometrically shaped as an annulus.

The general configuration of the aforementioned components allows the present invention to create a spray pattern that results in a better fuel efficiency. The dimple portion 6 is centrally positioned on the disc body 2 so that the dimple portion 6 is able to receive the most fuel and is able to shape the most fuel into a spray pattern with a better fuel efficiency before injecting the spray pattern into a cylinder. The annular portion 3 is peripherally connected to the dimple portion 6, which prevents the annular portion 3 from interfering in the shaping of the spray pattern and allows the annular portion 3 to act as a brim to hold the flow disc 1 in place. Each of the plurality of spray holes 9 traverses normal through the disc body 2, which allows the fuel to pass through the disc body 2 and simultaneously allows the dimple portion 6 to shape the spray pattern. The plurality of spray holes 9 is distributed across the disc body 2 so that the fuel is able to evenly pass through the disc body 2 and prevents an unnecessary back pressure in the fuel injector 10. The plurality of spray holes 9 may also be radially distributed from a center of the disc body 2 in order provide a better equidistant distribution for the plurality of spray holes 9. The spray tip 12 is terminally positioned on the injector body 11 as the spray tip 12 is used by the fuel injector 10 as the release point of the fuel into a cylinder. The flow disc 1 is mounted into the spray tip 12 as a way to modify the spray pattern as the fuel exits the fuel injector 10. The flow disc 1 is preferably configured to produce a conical-shaped spray pattern through the plurality of spray holes 9.

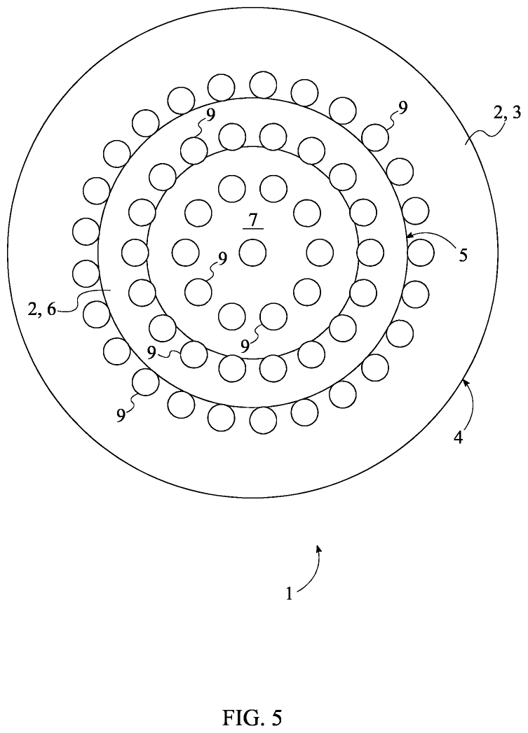

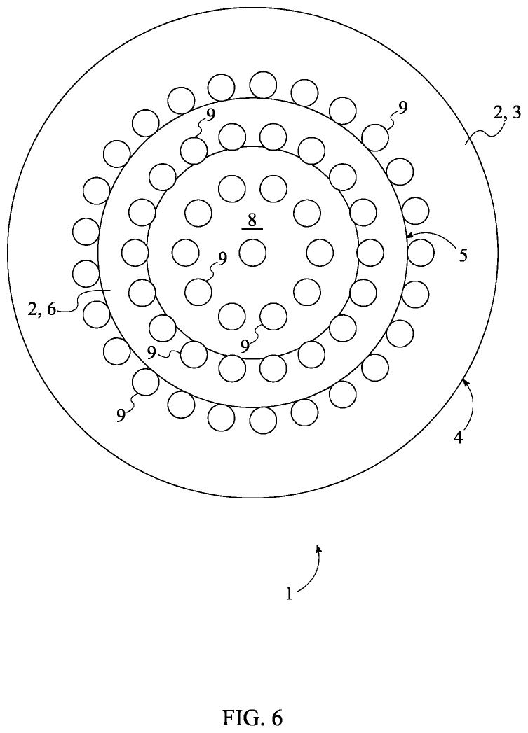

As can be seen in FIGS. 5 and 6, the plurality of spray holes 9 needs to be positioned in the proper area on the flow disc 1 in order to better shape the spray pattern of the fuel. Thus, the annular portion 3 comprises an outer edge 4 and an inner edge 5, which means that the outer edge 4 is positioned around and offset from the inner edge 5. The inner edge 5 is peripherally connected to the dimple portion 6, and the plurality of spray holes 9 is positioned offset from the outer edge 4 so that the spray pattern can be shaped without interference from the connection between the outer edge 4 and the interior of the spray tip 12.

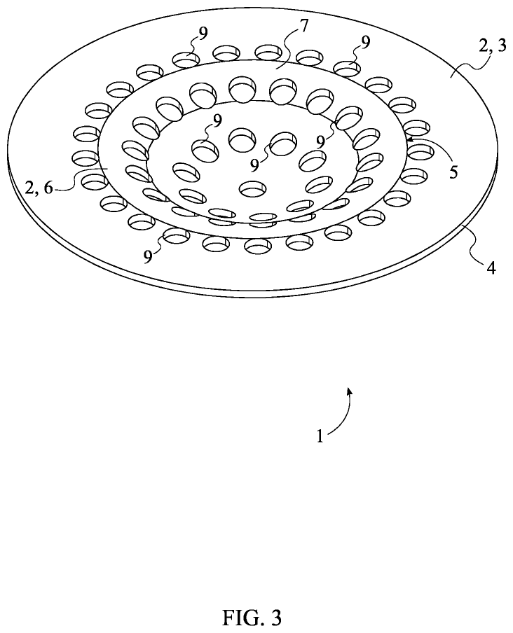

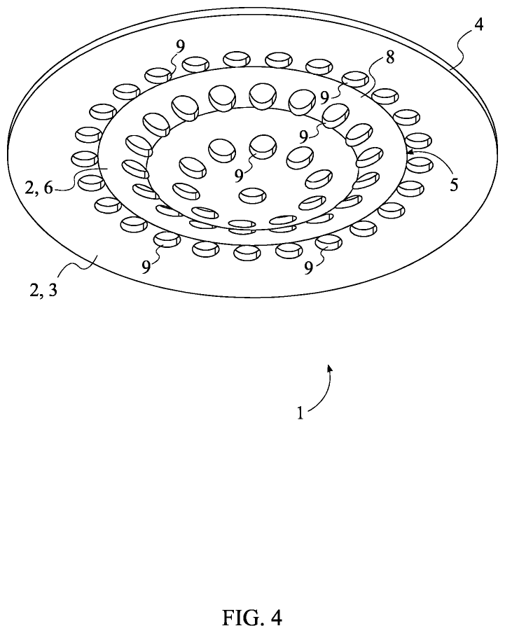

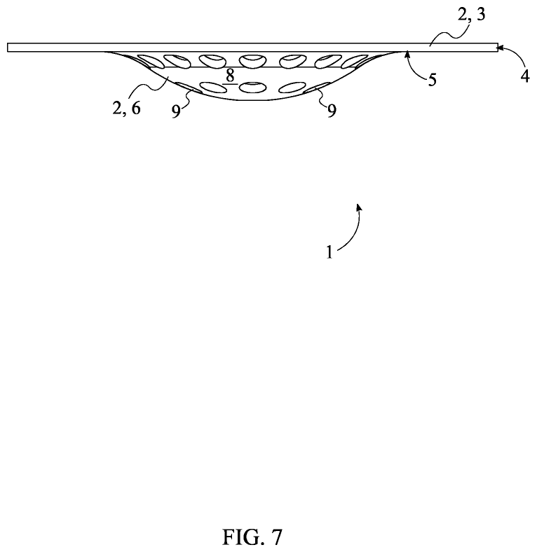

As can be seen in FIGS. 2 through 7, the dimple portion 6 needs to be oriented in the proper direction with the fuel injector 10 in order to better shape the spray pattern of the fuel. Thus, the dimple portion 6 comprises a concave surface 7 and a convex surface 8. The concave surface 7 is oriented towards the injector body 11, and the convex surface 8 is oriented away from the injector body 11, which allows the flow disc 1 to create the conical-shaped spray pattern discussed above.

As can be seen in FIGS. 1 and 2, the flow disc 1 needs to be properly secured to the fuel injector 10. Thus, the fuel injector 10 may further comprise an annular groove 13.

In more detail, the annular groove 13 is positioned within the spray tip 12 and is integrated into the spray tip 12. The annular portion 3 (i.e., the outer edge 4) is engaged into the annular groove 13, which secures the flow disc 1 in place as fuel passes through the flow disc 1.

The present invention can be configured in a variety of dimensions. In one set of dimensions of the present invention, a depth of the dimple portion 6 is between 0.010 inches and 0.090 inches, and a diameter of the annular portion 3 is 0.292 inches with a tolerance of +0.070 inches to −0.070 inches. In another set of dimensions for the present invention, a depth of the dimple portion 6 is between 0.010 inches and 0.115 inches, and a diameter of the annular portion 3 is 0.354 inches with a tolerance of +0.070 inches to −0.070 inches. In another set of dimensions for the present invention, a thickness of the disc body 2 is 0.005 inches with a tolerance of +0.010 inches to −0.002 inches.

### Supplemental Description

The present invention is a flow disc with a unique shape that can be utilized within a fuel injector. An objective of the present invention is to provide users with a flow disc that can increase the air to fuel ratio, by increasing the surface area of the available fuel, thus increasing the engine efficiency. The present invention intends to provide users with a device that can change the spray pattern of the exiting fuel increasing the surface area in contact with the air. To accomplish this the present invention comprises a disc depression, a plurality of holes, and an outer disc. Many of these components allow for the flow disc to vary the flow rate of the fuel and alter the shape of the spray pattern. All three sections are positioned on the flow disc with the disc depression residing in the concentric center, the plurality of holes positioned all along the flow disc surface and the outer disc positioned along the circumferential edge. The disc depression allows for the spray pattern of the exiting fuel to be altered, resulting in a larger surface area. Thus, the present invention is flow disc for a fuel injector that is designed with a unique shape to improve the metering and spray pattern to create a more efficient engine output while utilizing the same amount of fuel.

The flow disc changes the spray pattern of the exiting fuel from the fuel injector. The flow disc is preferably made with a stainless-steel material with a circular shape but is not limited to this material. This material allows the flow disc to be molded and shaped in various ways without putting stress and strain on the material while also providing anti-corrosion properties to ensure the durability of the flow disc. In its preferred embodiment the flow disc comprises a disc depression, a plurality of holes, and an outer disc. The disc depression is located in the concentric center of the flow disc. The disc depression is designed with a spherical depression with varying depths of depression, preferably deeper in the center of the flow disc and becoming shallower towards the outer edges near the outer disc. This spherical depression design creates a conical-shaped spray pattern which increases the total surface area of the exiting fuel that comes into contact with the air. This design creates a spray pattern with directional flow spreading away from each other creating atomization and a larger spray pattern compared to a linear spray pattern. Additionally, the spherical depression influences the spray pattern by creating a turbulent flow directly above the flow disc. This results in a sheering of fuel as it passes through the flow disc, creating smaller fuel droplets, increasing the total surface area of the fuel, which in turn improves the engine efficiency. It should be further noted that, the flow disc can be created in many various shapes and sizes and the disc depression can be shaped with various radii while still staying within the scope of the present invention.

The outer disc section is positioned along the circumferential edge of the flow disc. In its preferred embodiment the outer disc section can be created with various thicknesses from 0.001 inches to 0.025 inches each of which creates a different and unique flow pattern. Each flow disc can be designed with a specific thickness and is not limited to any of the aforementioned measurements. The thickness combined with the stainless-steel material ensures that the flow disc can be easily molded into various shapes and sizes for the disc depression. Furthermore, this design allows for the user of corrosive fuels within the fuel injector such as methanol/alcohol without the concern of damaged components as a result of the corrosive fuel. Positioned along the entire surface of the flow disc is the plurality of holes. The plurality of holes directly influences the spray pattern and the fuel flow rate. The plurality of holes is the location where the fuel exits the fuel injector with the desired fuel spray pattern. The plurality of holes can be increased or decreased by number or size to raise or lower the fuel flow rate. In the preferred embodiment of the flow disc the plurality of holes is positioned with concentric circle shapes. This design ensures that the spray pattern has a circular shape due to the plurality of holes and is sprayed outwards by the disc depression, resulting in a conical-shaped spray pattern. Furthermore, this creates an increase in surface area of the fuel being dispersed which lowers the time required to complete the combustion process, creating an engine with an increased efficiency. With all the components working in tandem with each other it can be seen that the present invention is flow disc for a fuel injector that is designed with a unique shape and a plurality specifically positioned holes to increase surface area of fuel and spray pattern, creating a more efficient engine output while utilizing the same amount of fuel.

Although the invention has been explained in relation to its preferred embodiment, it is to be understood that many other possible modifications and variations can be made without departing from the spirit and scope of the invention as hereinafter claimed.

What is claimed is:

1. A system of using a flow disc to modify a spray pattern of a fuel injector comprising:
a flow disc;
a fuel injector;
the flow disc comprising a disc body and a plurality of spray holes;
the fuel injector comprising an injector body and a spray tip;
the disc body comprising an annular portion and a dimple portion;
the dimple portion being centrally positioned on the disc body;
the annular portion being peripherally connected to the dimple portion;
each of the plurality of spray holes traversing normal through the disc body;
the plurality of spray holes being distributed across the disc body;
the spray tip being terminally positioned on the injector body; and
the flow disc being mounted into the spray tip.

2. The system as claimed in claim 1 comprising:
the annular portion comprising an outer edge and an inner edge;
the outer edge being positioned around and offset from the inner edge;
the inner edge being peripherally connected to the dimple portion; and
the plurality of spray holes being positioned offset from the outer edge.

3. The system as claimed in claim 1 comprising:
the plurality of spray holes being radially distributed from a center of the disc body.

4. The system as claimed in claim 1, wherein the flow disc is configured to produce a conical-shaped spray pattern through the plurality of spray holes.

5. The system as claimed in claim 1 comprising:
the dimple portion comprising a concave surface and a convex surface;
the concave surface being oriented towards the injector body; and
the convex surface being oriented away from the injector body.

6. The system as claimed in claim 1, wherein the dimple portion is geometrically shaped as a spherical cap.

7. The system as claimed in claim 1, wherein the annular portion is geometrically shaped as an annulus.

8. The system as claimed in claim 1, wherein a depth of the dimple portion is between 0.010 inches and 0.090 inches, and wherein a diameter of the annular portion is 0.292 inches with a tolerance of +0.070 inches to −0.070 inches.

9. The system as claimed in claim 1, wherein a depth of the dimple portion is between 0.010 inches and 0.115 inches, and wherein a diameter of the annular portion is 0.354 inches with a tolerance of +0.070 inches to −0.070 inches.

10. The system as claimed in claim 1, wherein the disc body is made of 304L stainless steel.

11. The system as claimed in claim 1, wherein a thickness of the disc body is 0.005 inches with a tolerance of +0.010 inches to −0.002 inches.

12. The system as claimed in claim 1 comprising:
the fuel injector further comprising an annular groove;
the annular groove being positioned within the spray tip;
the annular groove being integrated into the spray tip; and
the annular portion being engaged into the annular groove.
